(19) United States
(12) Patent Application Publication
(10) Pub. No.: US 2011/0063082 A1
(43) Pub. Date: Mar. 17, 2011

(54) WIRELESS TAG READER AND WIRELESS TAG READING METHOD

(75) Inventors: Fumihiko Ikegami, Kanagawa (JP); Yoshinori Sato, Shizuoka (JP)

(73) Assignee: TOSHIBA TEC KABUSHIKI KAISHA, Tokyo (JP)

(21) Appl. No.: 12/874,572

(22) Filed: Sep. 2, 2010

(30) Foreign Application Priority Data
Sep. 17, 2009 (JP) 2009-215964

(51) Int. Cl. G06K 7/01

(52) U.S. Cl. 340/10.1

(57) ABSTRACT

According to one embodiment, a wireless tag reader includes a receiver, a memory, a reader, and a transmitter. The receiver configured to receive an instruction from a host. The memory configured to store a dummy identifier, when the receiver received a set instruction for setting the dummy identifier from the host. The reader configured to read information stored in a wireless tag, when the receiver received a read instruction from the host. The transmitter configured to add the dummy identifier to the information, and to transmit the information, to which the dummy identifier is added, to the host.

### CROSS-REFERENCE TO RELATED APPLICATIONS

This application is based upon and claims the benefit of priority from prior Japanese Patent Application No. 2009-215964, filed on Sep. 17, 2009; the entire contents of which are incorporated herein by reference.

### FIELD

Embodiments described herein relate generally to a wireless tag reader, and a wireless tag reading method which reads information stored in a wireless tag by non-contact communication.

### BACKGROUND

There is known an RFID (Radio Frequency Identification) system which non-contactly reads information of a wireless tag attached to an article, for example, a commodity, and delivers the read information to an upper-level application. The RFID system comprises a plurality of wireless readers; an RFID middleware which acquires from the wireless readers a list of identifiers of wireless tags, which is a read result of the wireless readers, and performs processes such as merging (elimination of overlapping identifiers), filtering and group-classification; a database which receives and stores a process result from the RFID middleware; and an application which refers to the read result stored in the database. As regards the entire RFID system including the RFID middleware, the specifications of the interface between the modules of the RFID system (wireless tag readers, middleware and database) are standardized by the international organization EPCglobal, as disclosed in the EPCglobal standard specifications <http://www.epcglobalinc.org/standards>.

By implementing these modules based on the interface specifications, such merits can be obtained that a wireless tag reader of company A and an RFID middleware of company B, for instance, are connected, and company X and company Y may mutually refer to read results stored in their databases and utilize the read results. Thus, RFID systems, which adopt the above-described interface specifications, have widely been used in the fields of logistics and distributions of goods.

In the meantime, as a method of detecting a fault of a device (module) in the system, wide use is made of a keep-alive method in a network communication, wherein a packet indicating that the communication of a terminal is still effective is periodically sent out as a heartbeat, and a counter-part terminal determines that the communication is disconnected if such a packet is no longer received.

However, in the interface specifications stipulated in the EPCglobal, the information relating to the abnormality occurring in the wireless tag reader is included neither in the information which is transmitted from the wireless tag reader to middleware, nor in the information which is transmitted from the middleware to the database. Thus, in the hierarchical layers above the middleware, there is such a problem that when the read result is indicative of “empty” (no data), it is not possible to discriminate whether no wireless tag is present near the wireless tag reader, or a fault occurs in the wireless tag reader.

If the keep-alive method is applied to the wireless tag reader, a fault can be detected. However, in the RFID system according to the EPCglobal specifications, the keep-alive signal is not standardized, and therefore the mutual connectability is not maintained. In addition, since keep-alive signals from wireless tag readers are individually transmitted independently from read results, it is difficult to determine which of read results is associated with a fault which has occurred.

Thus, there is a demand for a wireless tag reader which can determine the condition of a read operation, without the need to provide a special structure for fault detection.

### BRIEF DESCRIPTION OF THE DRAWINGS

FIG. 1 is an exemplary block diagram showing the structure of an RFID system according to a first embodiment;

FIG. 2 is an exemplary flow chart illustrating an operation in a case where a read instruction is received in a reader in the first embodiment;

FIG. 3 is an exemplary flow chart illustrating an operation of a middleware module in a host PC in the first embodiment;

FIG. 4 is an exemplary block diagram showing the structure of an RFID system according to a second embodiment;

FIG. 5 is an exemplary view showing an example of a dummy identifier which is transmitted from a setup tool module to a reader in the second embodiment;

FIG. 6 is an exemplary flow chart illustrating an operation in a case where a read instruction is received in a reader in the second embodiment;

FIG. 7 is an exemplary flow chart illustrating an operation of a middleware module in a host PC in the second embodiment; and

FIG. 8 is an exemplary block diagram showing the structure of an RFID system according to a third embodiment.

### DETAILED DESCRIPTION

In general, according to one embodiment, there is provided a wireless tag reader includes a reception module, a storage module, a read module, and a transmission module. The reception module configured to receive an instruction from a host. The storage module configured to store a dummy identifier, when the reception module has received a set instruction for setting the dummy identifier from the host. The read module configured to read information stored in a wireless tag, when the reception module received a read instruction from the host. The transmission module configured to add the dummy identifier to the information, and to transmit the information, to which the dummy identifier is added, to the host.

Embodiments will now be described with reference to the drawings.

### First Embodiment

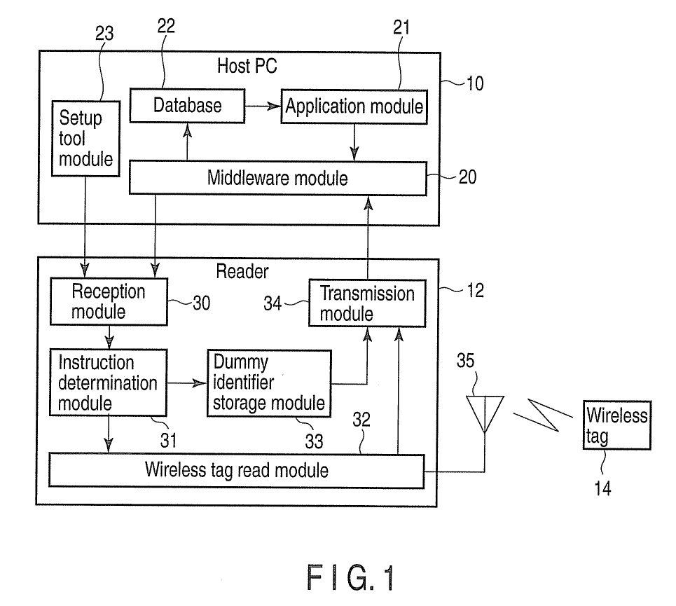

FIG. 1 is a block diagram showing the structure of an RFID system in a first embodiment. As shown in FIG. 1, in the RFID system, a host PC 10 and a reader 12 (wireless tag reader) are connected via a network.

Although FIG. 1 shows only one reader 12, a plurality of readers 12 may be configured to be connected to the host PC 10. It is assumed that the RFID system of the first embodiment is constructed according to, e.g. the EPCglobal specifications. Under the control of the host PC 10 (middleware module 20), the reader 12 non-contactly reads a tag ID (tag information) stored in a wireless tag 14 which is attached to a single article (e.g. commodity) or each of a plurality of articles. The tag ID is representative of an identifier, and includes, for instance, data representing a company code, a commodity item code and a commodity production number, as well as a header for identifying a code system.

The host PC 10 realizes respective functions by executing various programs by a processor. The host PC 10 is configured to control the reader 12, thereby executing control to read information from the single or plural wireless tags 14, and the host PC 10 is provided with functions of a middleware module 20, an application module 21, a database 22 and a setup tool module 23.

Based on read setup information from the application module 21 which is set by a system administrator, the middleware module 20 transmits various instructions to the reader 12 and controls reading of information from the wireless tag(s) 14, and also processes information relating to the wireless tag(s) 14 which has been read by the reader 12. The read setup information includes information relating to the designation of the reader which is used for reading the wireless tag 14, information on the conditions for filtering or grouping of the information read from the wireless tag 14, and information relating to the designation of, e.g. time intervals of wireless tag read. The middleware module 20 has a function of determining the operation condition of the reader 12 by checking whether a dummy identifier, which is different from an identifier (tag ID) of the wireless tag(s) 14 which is read from the single or plural wireless tag(s) 14, is included in the read result which is received from the reader 12.

The application module 21 creates read setup information according to an instruction from the system administrator, informs the middleware module 20 of the read setup information, and executes a process on the information which is read from the wireless tag(s) 14 by the reader 12, based on the read setup information.

The database 22 stores the read result which has been processed by the middleware module 20.

The setup tool module 23 is a function for enabling the system administrator to execute various settings on the reader 12. The setup tool module 23 executes various settings according to instructions which are input from an input device by the system administrator, and sends the settings to the reader 12 (reception module 30). In the first embodiment, a dummy identifier, which is used in order to determine the operation condition of the reader 12, is set and sent to the reader 12. Preferably, the dummy identifier should be a fictitious identifier which cannot be read as the identifier of the wireless tag 14.

On the other hand, the reader 12 non-contactly reads, under the control of the host PC 10 (middleware module 20), the information stored in the single or plural wireless tag(s) 14, which are present around the reader 12. As shown in FIG. 1, the reader 12 includes a reception module 30 (receiver), an instruction determination module 31, a wireless tag read module 32 (reader), a dummy identifier storage module 33 (memory), a transmission module 34 (transmitter) and an antenna 35.

The reception module 30 receives via the network various instructions and data which are sent from the host PC 10.

The instruction determination module 31 determines the kind of an instruction which is received by the reception module 30, and instructs, for example, the wireless tag read module 32 to execute a read process and instructs the dummy identifier storage module 33 to store a dummy identifier which is received from the host PC.

When the instruction determination module 31 has determined that the instruction from the host PC 10 is a read instruction, the wireless tag read module 32 executes reading of the information (tag ID) stored in the wireless tag 14 via an antenna 35.

When the instruction determination module 31 has determined that the instruction from the host PC 10 is a set instruction for setting a dummy identifier from the host PC 10 (setup tool module 23), the dummy identifier storage module 33 stores the dummy identifier which is sent from the host PC 10.

The transmission module 34 creates a list comprising information (identifier(s) indicated by tag ID(s)) which is read from the wireless tag(s) 14 by the wireless tag read module 32, adds to the list the dummy identifier stored in the dummy identifier storage module 33, and sends the list to the host PC 10 (middleware module 20) as the read result.

Next, the operation of the RFID system of the first embodiment is described with reference to flow charts.

The system administrator sets a dummy identifier, which is provided to the reader 12, by making use of the setup tool module 23 in the host PC 10. Preferably, the dummy identifier should be chosen from identifiers which cannot be read from the antenna 35 connected to the reader 12. If the transmission of the dummy identifier is instructed by the system administrator, the setup tool module 23 transmits a set instruction, together with the set dummy identifier, to the reader 12.

The instruction determination module 31 determines the instruction which is received by the reception module 30. If the received instruction is a set instruction for setting the dummy identifier, the instruction determination module 31 transmits the dummy identifier set instruction, together with the dummy identifier, to the dummy identifier storage module 33.

The dummy identifier storage module 33 stores the received dummy identifier via the instruction determination module 31. It is not necessary that the number of dummy identifiers is one, and a plurality of dummy identifiers may be stored. For example, a plurality of dummy identifiers may be cumulatively stored in the dummy identifier storage module 33, or a plurality of dummy identifiers may be received batchwise from the setup tool module 23 of the host PC 10 and stored.

If the system administrator completes the setting of the dummy identifier by using the setup tool module 23, the system administrator activates the middleware module 20. The middleware module 20 sends to the reader 12 a read instruction for reading the wireless tag 14.

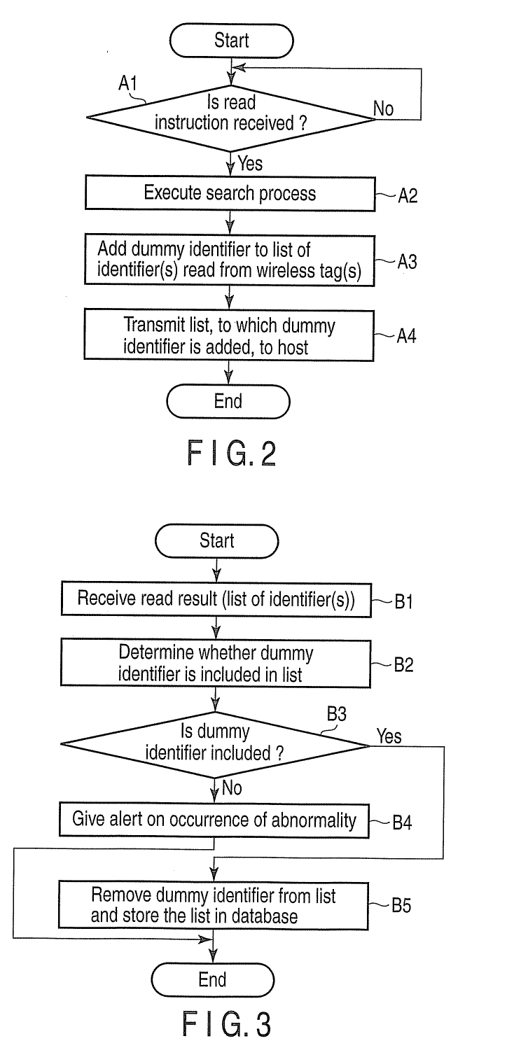

FIG. 2 is a flow chart illustrating an operation in a case where the read instruction is received in the reader 12.

The reader 12 receives, by the reception module 30, the instruction which is sent from the middleware module 20, and determines the kind of the instruction by the instruction determination module 31. If the instruction determination module 31 determines that the read instruction has been received (Yes in Act A1), the instruction determination module 31 notifies the wireless tag read module 32 of the execution of the read process.

Responding to the notification from the instruction determination module 31, the wireless tag read module 32 executes a search process for reading information from the single or plural wireless tags 14, which are present around the antenna 35 (Act A2). Thereby, the wireless tag read module 32 searches the wireless tag(s) 14 which is present in a searchable range (range of communication) from the antenna 35, and executes read of information (tag ID) including the identifier stored in the wireless tag(s) 14.

If the wireless tag read module 32 acquires information from the wireless tag(s) 14 within the searchable range (range of communication) and completes the search process, the wireless tag read module 32 sends to the transmission module 34 a list of the identifiers(s) read from the wireless tag(s) 14.

If a list of identifier(s) (including cases of “empty” (no data)) is sent from the wireless tag read module 32 to the transmission module 34, the transmission module 34 accesses the dummy identifier storage module 33, reads out the stored dummy identifier, and adds the dummy identifier to the list of identifier(s) (Act A3).

The transmission module 34 transmits the list, to which the dummy identifier is added, to the host PC 10 (middleware 20) as the read result (Act A4).

Accordingly, when information has been read from at least one wireless tag 14 by the wireless tag read module 32, the reader 12 transmits the list including the read information (identifier) and the dummy identifier. When no information has been read from the wireless tag 14 (when no wireless tag 14 is present in the searchable range of the antenna 35), the reader 12 transmits the list including only the dummy identifier.

FIG. 3 is a flow chart illustrating the operation of the middleware module 20 in the host PC 10.

In the host PC 10, if the middleware module 20 receives the read result (the list of identifier(s)) (Act B1), the middleware module 20 checks whether a dummy identifier is included in the list (Act B2).

If a dummy identifier is included in the list (Yes in Act B3), the middleware module 20 determines that the read by the reader 12 has normally been executed.

Specifically, in the case where the reader 12 has normally executed the read operation and the middleware module 20 has normally received the list that is the read result, at least the dummy identifier is recorded in the list even if there is no identifier read from the wireless tag 14. Therefore, it can be determined that the read has normally been executed.

In this case, the middleware module 20 removes the dummy identifier from the list of the read result, and stores in the database 22 only the identifier which is read from the wireless tag 14 which is actually present around the antenna 35 (Act B5).

On the other hand, if no dummy identifier is included in the list of the read result, that is, if the read result is completely “empty” (no data), it can be determined that a fault has occurred in the reader 12 or a fault has occurred in the communication path between the reader 12 and the host PC 10 (No in Act B3). If the occurrence of such abnormality is determined, the middleware module 20 executes, for example, a process of alerting the system administrator to the occurrence of abnormality (Act B4). For example, the middleware module 20 displays an alert message on the display screen of the host PC 10, or outputs an alert sound from a speaker.

Thereby, the system administrator can recognize that a fault has occurred in the reading of the information from the wireless tag 14 via the reader 12.

In the above description, the occurrence of abnormality is determined in the middleware module 20. Alternatively, the application module 21 may be configured to execute the process of determining the occurrence of abnormality. In this case, the middleware module 20 stores in the database 22 the read result including a dummy identifier, which is received from the reader 12. The application module 21 refers to the read result stored in the database 22, and determines abnormality by checking whether a dummy identifier is included or not, in the same manner as described above.

In this case, since the each-time read execution result stored in the database 22 includes the information indicating whether the read has normally been executed, there is a merit that the application module 21 can easily recognize the time of occurrence of abnormality, when the database 22 is referred to later.

In the RFID system of the first embodiment, it is not necessary to set the dummy identifier when the information from the wireless tag 14 is read. If there is no need to detect the abnormality of read, the setting of the dummy identifier from the setup tool module 23 is not executed. The reader 12 operates as an ordinary reader, executes a read process according to a read instruction from the middleware module 20, and transmits to the host PC 10 the list of the read result, which does not include a dummy identifier. The respective functions of the reader 12 in the first embodiment may be realized not only by hardware, but also by software (program) which operates in the computer.

In this manner, in the reader 12 (wireless tag reader) in the first embodiment, the dummy identifier, which is set by the setup tool module 23, is added to the read result corresponding to the single or plural wireless tag(s), and the read result is transmitted to the host PC 10. Thus, the middleware module 20, database 22 or application module 21 checks whether the dummy identifier is included in the read result, thus being able to determine the operation condition of the reader 12. Specifically, when the read result is “empty”, it is possible to determine whether the reason is that the wireless tag 14 was not present nearby although the read process was normally performed in the reader 12, or that abnormality occurred in the reader 12 itself or in the communication path between the reader 12 and the host PC 10 (middleware module 20) although the wireless tag 14 was present nearby. According to the RFID system of the first embodiment, the operation condition in the reader 12 can be recognized in the host PC 10, without expanding the interface specifications stipulated by the EPCglobal, for example, without providing a function for a signal (e.g. keep-alive signal) for notifying the operation condition of the reader 12.

### Second Embodiment

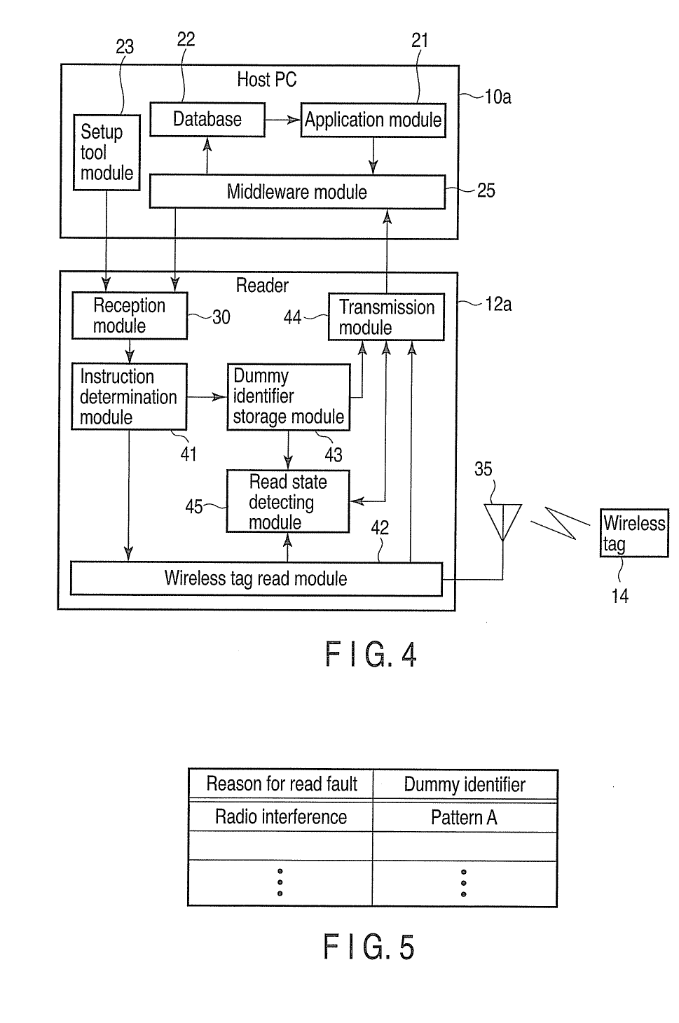

Next, a second embodiment is described. FIG. 4 is a block diagram showing the structure of an RFID system according to the second embodiment.

As shown in FIG. 4, a reader 12a in the second embodiment includes a reception module 30, an instruction determination module 41, a wireless tag read module 42, a dummy identifier storage module 43, a transmission module 44 and a read state detecting module 45 (detector). Specifically, in the reader 12 of the second embodiment, the read state detecting module 45, which checks the state of the read process in the wireless tag read module 42, is additionally provided in the structure shown in FIG. 1, which has been referred to in the description of the first embodiment. The functional modules, which are indicated by the same terms as in the structure shown in FIG. 1, execute basically the same functions as in the first embodiment, and a detailed description thereof is omitted here. Different parts will be described below.

Next, the operation of the REID system of the second embodiment is described with reference to a flow chart.

In the second embodiment, when the system administrator sets a dummy identifier, which is set in the dummy identifier storage module 43, by using the setup tool 23, the system administrator can set a plurality of different dummy identifiers in accordance with reasons of abnormality (reasons for information read fault) occurring at the time of the read process.

It is assumed that the process of transmitting the read instruction to the wireless tag read module 42 after the setting of dummy identifiers is the same as in the first embodiment.

FIG. 5 shows an example of the dummy identifier which is transmitted from the setup tool module 23 to the reader 12a. For example, in FIG. 5, a dummy identifier by a pattern A is set in association with the kind of abnormality, “Radio interference”, which may possibly occur in the reader 12a. In addition, different dummy identifiers according to patterns B and C are set in association with other kinds of abnormality. In the meantime, it is assumed that the kinds of abnormality (reasons for information read fault), for which dummy identifiers are set, can be checked by the read state detecting module 45 of the reader 12a.

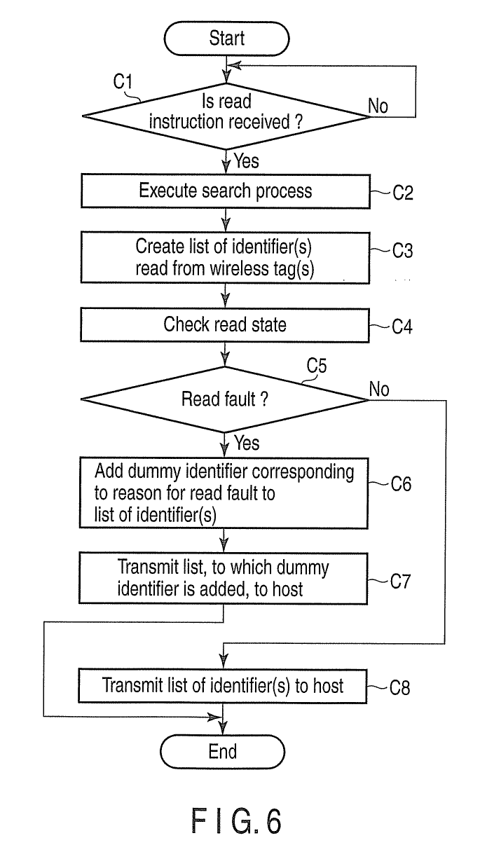

FIG. 6 is a flow chart illustrating an operation in a case where a read instruction is received in the reader 12a.

The reader 12a receives, by the reception module 30, an instruction which is sent from a middleware module 25, and determines the kind of the instruction by the instruction determination module 41. If the instruction determination module 41 determines that the read instruction has been received (Yes in Act C1), the instruction determination module 41 notifies the wireless tag read module 42 of the execution of the read process.

Responding to the notification from the instruction determination module 41, the wireless tag read module 42 executes a search process for reading information from the single or plural wireless tags 14, which are present around the antenna 35 (Act C2). Thereby, the wireless tag read module 32 searches the wireless tag(s) 14 which is present in a searchable range (range of communication) from the antenna 35, and executes read of information (tag ID) including the identifier stored in the wireless tag(s) 14.

If the wireless tag read module 42 acquires information from the wireless tag(s) 14 within the searchable range (range of communication) and completes the search process, the wireless tag read module 42 creates a list of identifiers read from the wireless tags 14 and sends the list to the transmission module 44 (Act C3). Further, the wireless tag read module 42 sends to the read state detecting module 45 the information relating to the search process, for instance, the reception level of radio waves sent from the wireless tag 14, the interference state of radio waves in the vicinity, which is measured by the antenna 35, and the free memory area for buffering, which is used for temporarily storing the read result.

The read state detecting module 45 checks the state of the read process, based on the information acquired from the wireless tag read module 42, and determines whether a read fault has occurred or not (Act C4). For example, if an interference of radio waves in the vicinity is great, a read fault is determined and the reason for the read fault is determined to be “Radio interference”.

If a list of identifier(s) (including cases of “empty” (no data)) is sent from the wireless tag read module 42 to the transmission module 44, the transmission module 44 accesses the read state detecting module 45. In the case where the read state detecting module 45 has been accessed by the transmission module 44, if the read fault is determined (Yes in Act C5), the read state detecting module 45 reads out of the dummy identifier storage module 43 the dummy identifier corresponding to the reason (e.g. radio interference) of the read fault, and returns the dummy identifier to the transmission module 44.

If the dummy identifier is returned from the read state detecting module 45, the transmission module 44 adds the dummy identifier to the list of identifiers sent from the wireless tag read module 42 (Act C6).

The transmission module 44 transmits the list, to which the dummy identifier is added, to the host PC 10 (middleware module 25) as the read result (Act C7).

On the other hand, if the read state detecting module 45 does not determine the state of a read fault (No in Act C5), the read state detecting module 45 does not return a dummy identifier in response to the access from the transmission module 44.

The transmission module 44 transmits the list of identifiers, which is sent from the wireless tag read module 42, to the host PC 10a (middleware module 25) (Act C8).

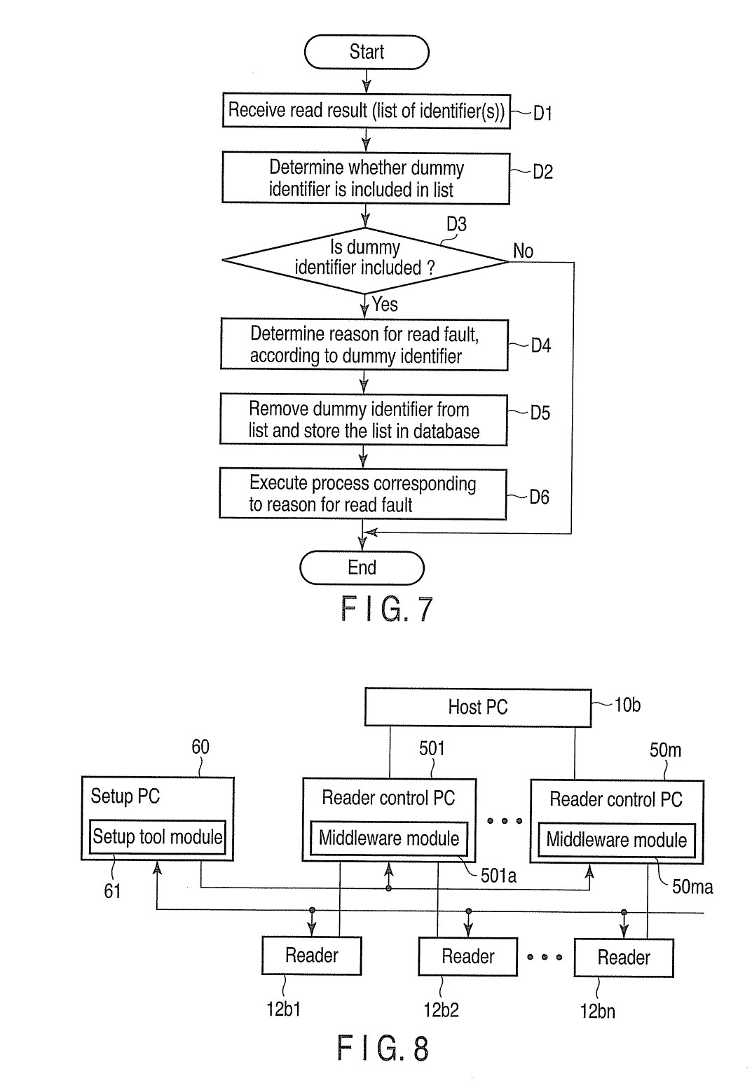

FIG. 7 is a flow chart illustrating the operation of the middleware module 25 in the host PC 10a.

In the host PC 10a, if the middleware module 25 receives the read result (the list of identifiers) (Act D1), the middleware module 25 checks whether a dummy identifier is included in the list (Act D2).

If a dummy identifier is included in the list (Yes in Act D3), the middleware module 25 determines, based on the kind of the dummy identifier, the reason for a read fault which has been detected by the reader 12a (Act D4).

The middleware module 25 removes the dummy identifier from the list of the read result, and stores in the database 22 only the identifier recorded in the list (Act D5).

Then, the middleware module 25 executes a process corresponding to the reason for a read fault (Act D6). For example, like the first embodiment, an alert is output. Further, in the second embodiment, for example, when the reason for a read fault is a radio interference, consideration is given to the fact that even if the next read instruction is immediately issued, it is highly possible that the sending of the read instruction would fail due to radio interference once again. Thus, the middleware module 25 re-transmits the read instruction after a time interval. In this manner, since the dummy identifier corresponding to the reason for a read fault is added to the list from the host PC 10a, a more specified measure can be taken when a read fault has occurred.

On the other hand, when the dummy identifier is not included in the list, the middleware module 25 determines that the read has normally been executed, and stores in the database 22 the identifier recorded in the list.

In the above-described second embodiment, when the read fault is not determined by the read state detecting module 45, the dummy identifier is not added to the list of identifiers. However, like the first embodiment, a specific dummy identifier, which is not associated with the reason for a read fault, may be added to the list, and the list with the specific dummy identifier may be transmitted.

The modifications described in connection with the first embodiment, for example, the process of determining abnormality in the application module 21, may be applied to the second embodiment.

As has been described above, according to the second embodiment, in addition to the structure and advantageous effects of the first embodiment, when abnormality occurs in the reader 12, different dummy identifiers are added according to reasons for such abnormality. Thus, the occurrence of abnormality can be detected by the middleware module 20 or application module 21, and moreover the reason for such abnormality can be recognized.

### Third Embodiment

In the first and second embodiments, the setup tool module 23, which sets the dummy identifier in the reader 12, 12a, is provided in the host PC 10, 10a.

Alternatively, as shown in FIG. 8, the setup tool module may be realized in the system structure of an RFID system as shown in FIG. 8.

In the RFID system shown in FIG. 8, a plurality of reader control PCs 501, . . . , 50m operate under the control of a host PC 10b.

Middleware modules 501a, . . . , 50ma, which function as in the first and second embodiments, are provided in the reader control PCs 501, . . . , 50m. In the third embodiment, there is provided a setup PC 60 which is connected to the plural readers 12b1, 12b2, . . . , 12bn via a network, and a setup tool module 61 is operated in the setup PC 60.

The setup tool module 61 is configured to be capable of setting a common dummy identifier or different dummy identifiers in the plural readers 12b1, 12b2, . . . , 12bn.

In the RFID system in the third embodiment, the respective reader control PCs 501, . . . , 50m do not set dummy identifiers, but the common dummy identifier can be commonly set in the plural readers 12b1, 12b2, . . . , 12bn by the setup PC 60 (setup tool module 61). Thus, the load on the system administrator for the management of dummy identifiers can be reduced.

In the above description, when the instruction for setting the dummy identifier is issued from the host PC 10, the dummy identifier is added to the information (identifier) read from the wireless tag 14, and the read information (identifier) together with the dummy identifier is transmitted as the read result. Alternatively, in a situation other than the case where the instruction for setting the dummy identifier is received, it is possible to add the dummy identifier and to transmit the read result. For example, the dummy identifier can be added in the case where the dummy identifier is usually added and transmitted as the read result, the dummy identifier is added only during a preset period, or specific information which is preset by the read setup is included (e.g. the case of a tag ID having a specific company code). When the dummy identifier is added in the case where the specific information is included, the data indicative of the target information is reported from the middleware module 20 to the wireless tag read module 32, 42. In this manner, the confirmation using the dummy identifier can be executed in accordance with the situation in which the confirmation of the operation condition of the reader 12 (wireless tag reader) is needed.

In the description of the present embodiments, the functions for implementing the present invention are provided in the reader 12. However, the present invention is not limited to this. A program for realizing similar functions may be downloaded from a network, or a program for realizing similar functions may be installed from a recording medium which stores the program. The recording medium may be any form of medium such as CD-ROM in which the program can be stored and from which the device can read the program.

The functions obtained by the installation or download may be implemented in cooperation with the OS or the like inside the device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless tag reader comprising:
a receiver configured to receive an instruction from a host;
a memory configured to store a dummy identifier, when the receiver received a set instruction for setting the dummy identifier from the host;
a reader configured to read information stored in a wireless tag, when the receiver received a read instruction from the host; and
a transmitter configured to add the dummy identifier to the information, and to transmit the information, to which the dummy identifier is added, to the host.

2. The wireless tag reader of claim 1, wherein the memory is configured to store a plurality of said dummy identifiers.

3. The wireless tag reader of claim 1, further comprising a detector configured to check a read state of the information which read from the wireless tag,
wherein the transmitter is configured to add the dummy identifier when the detector determines that the read state of the information is faulty.

4. The wireless tag reader of claim 1, further comprising a detector configured to check a read state of the information which read from the wireless tag,
wherein the memory is configured to store a plurality of dummy identifiers which correspond to read states, and
the transmitter is configured to add the dummy identifier corresponding to a read state which is checked by the detector.

5. The wireless tag reader of claim 4, wherein the transmitter is configured to add a specific dummy identifier which is associated with a faulty read state, when the detector check that the read state of the information is faulty.

6. A wireless tag reader comprising:
a receiver configured to receive an instruction from a host;
a memory configured to store a dummy identifier which is transmitted from a setup module;
a reader configured to read information stored in a wireless tag, when the receiver received a read instruction from the host; and
a transmitter configured to add the dummy identifier to the information which read from the wireless tag, and to transmit the information, to which the dummy identifier is added, to the host.

7. The wireless tag reader of claim 6, wherein the memory is configured to store a plurality of said dummy identifiers.

8. The wireless tag reader of claim 6, further comprising a detector configured to check a read state of the information which read from the wireless tag,
wherein the transmitter is configured to add the dummy identifier when the detector determines that the read state of the information is faulty.

9. The wireless tag reader of claim 6, further comprising a detector configured to check a read state of the information which read from the wireless tag,
wherein the memory is configured to store a plurality of dummy identifiers which correspond to read states, and
the transmitter is configured to add the dummy identifier corresponding to a read state which is checked by the detector.

10. The wireless tag reader of claim 9, wherein the transmission module is configured to add a specific dummy identifier which is associated with a faulty read state, when the detector check that the read state of the information is faulty.

11. A wireless tag reading method comprising:
receiving an instruction from a host;
storing a dummy identifier when receiving, from the host, a set instruction for setting the dummy identifier;
reading information stored in a wireless tag, when receiving a read instruction from the host; and
adding the dummy identifier to the information, and transmitting, to the host, the information with the dummy identifier added.

12. The wireless tag reading method of claim 11, wherein the storing the dummy identifier includes storing a plurality of dummy identifiers.

13. The wireless tag reading method of claim 11, further comprising detecting a read state of the information read from the wireless tag,
wherein the dummy identifier is added when detecting that the read state of the information is faulty.

14. The wireless tag reading method of claim 11, further comprising:
detecting read states of the information read from the wireless tag,
and wherein
the storing the dummy identifier includes storing a plurality of dummy identifiers which include the dummy identifier and correspond to the read states; and
the adding the dummy identifier includes adding dummy identifiers which include the dummy identifier and correspond to the detected read states.

15. The wireless tag reading method of claim 14, wherein the adding the dummy identifier includes adding a specific dummy identifier which is associated with one of the read states, when detecting that the one of the read states is faulty.
